(19) United States
(12) Patent Application Publication
(10) Pub. No.: US 2018/0250781 A1
(43) Pub. Date: Sep. 6, 2018

(54) AUTONOMOUS PRODUCTION LINE

(71) Applicant: ARRTSM GmbH, Dettenhausen (DE)

(72) Inventor: Yudhisthir Gauli, Dettenhausen (DE)

(21) Appl. No.: 15/899,104

(22) Filed: Feb. 19, 2018

(30) Foreign Application Priority Data
Mar. 1, 2017 (DE) DE102017104246.6

(51) Int. Cl. B23Q 7/14; B23Q 15/06

(52) U.S. Cl. CPC B23Q 7/1494; B23Q 15/06; B23Q 3/15526; B23Q 2717/00; B23Q 2703/04

(57) ABSTRACT

An autonomous production line for machining work pieces e.g. by sawing, milling, boring or grinding and proposes a roller conveyor with machining stations, a placement station and an unloading station. Machining robots machine the work pieces at the machining stations while the work pieces are supported on suction tables.

### RELATED APPLICATIONS

This application claims priority from and incorporated by reference German Patent Application DE 10 2017 104 246.6 filed on Mar. 1, 2017.

### FIELD OF THE INVENTION

The invention relates to an autonomous production line for machining individual work pieces.

### BACKGROUND OF THE INVENTION

Complete machining of individual work pieces in machining centers or machining individual work pieces in sequence on different machine tools like lathes, milling machines, and boring machines is known in the Art.

### BRIEF SUMMARY OF THE INVENTION

Thus, it is an object of the invention to propose a flexible autonomous production line for machining individual work pieces.

The object is achieved by an autonomous production line for machining work pieces, the autonomous production line comprising a feed arrangement configured to feed the work pieces to and from at least one machining station at which the work pieces are machined on the feed arrangement.

The production line according to the invention includes one or plural machining stations and a feed arrangement for feeding work pieces to and from the machining stations or for feeding work pieces to a machining station, from a machining station to another or a next machining station and for feeding the work pieces away from a last machining station. The feeding arrangement is in particular a continuous conveyor, for example a roller track or a belt conveyor which, however, does not have be operated continuously but can be operated for example in an intermittent manner in machining breaks between machining steps of work pieces at the machining stations. Advantageously the work pieces can be moved or feed independently from each other at different locations of the feed arrangement. This is possible for example with a rolling conveyor whose rollers are drivable individually per axle or in groups including plural sequential rollers.

The work pieces are machined at the machining stations, for example sawed, milled, bored or ground. During the machining the work pieces remain on the feed arrangement, this means the work pieces are not removed from the feed arrangement for machining and for example fed to a machining center or a machine tool and brought back onto the feed arrangement after machining. “On” does not have to have a three dimensional meaning in this context but indicates a remaining of the work pieces during machining at, on etc. the feed arrangement. For example a feed arrangement can be provide where the work pieces are arranged laterally or suspended. For example on a roller track or a band conveyor configured as a feed arrangement the work pieces are actually arranged on the feed arrangement and remain there during machining.

The invention facilitates machining different work pieces with almost unlimited and at least a multitude of machining options on an individual production line. Thus, different work pieces can be machined in different manners one after another. For example different work pieces like parts of a piece of furniture which are subsequently assembled or packaged can be machined one after the other in the sequence in which they are subsequently assembled or packaged. Certainly different work pieces can also be machined in sequence since they are not connected in any way. Thus, no retooling of the production line according to the invention is required for machining different work pieces that require different machining steps.

Advantageously the feed arrangement includes several machining stations along its path and/or at different locations, in particular on two sides adjacent to the feed arrangement but also above and below the feed arrangement. “Along its path” means along a feed path. This way plural work pieces can be machined simultaneously and each work piece can be machined simultaneously and/or sequentially at different machining stations. This facilitates quick and flexible machining of different work pieces and different machining steps of the work pieces like sawing, boring, milling grinding, with few tools and few tool changes and without reconfiguring the arrangement.

Advantageously the production line according to the invention includes a placement station which places the work pieces onto the feed arrangement and/or an unloading station which removes the work pieces from the feed arrangement. Advantageously, however, not necessarily the placement station is at one end of the feed arrangement and the unloading station is at another end of the feed arrangement. This facilitates automatic loading and unloading of the feed arrangement of the production line according to the invention with provided work pieces in addition to automated flexible machining.

One embodiment of the invention provides a fixing arrangement for each machining station wherein the fixing arrangement fixes the work pieces during machining on the feed arrangement so that the work pieces do not move during machining. It is feasible to lift and fix the work pieces by the fixing arrangement for machining, so that for example a roller conveyor or band conveyor does not have to be shut down during machining. However, it is also possible to stop a continuous conveyor and to fix the work pieces through at least one fixing arrangement for machining. A fixing arrangement can be associated with plural machining stations, for example two machining stations that are arranged opposite to one another at opposite sides of the feed arrangement.

The fixing device can clamp the work pieces mechanically for example with fixed and/or movable clamping jaws. An embodiment of the invention provides a clamping device with one or plural suction grippers which include in particular suction cups or a suction table for fixing the work pieces for machining at the machining stations. A suction table advantageously includes a flat surface with holes for pulling out air for suctioning and fixing the work piece. This requires work pieces with a suitable, in particular flat and/or smooth surface which facilitates fixing by a vacuum. The surface can be machined if necessary after flipping the work piece at the same or another work station. Differently from for example a mechanical clamping device which has to be adapted to a work piece a clamping device clamping work pieces with vacuum facilitates holding work pieces with random shapes which include a surface that is suitable for vacuum support. Put differently a fixing arrangement supporting the work pieces with vacuum is more universal with respect to different work pieces. Furthermore a fixing arrangement that operates with vacuum does not generate any impressions (clamping marks) at a work piece.

In order to determine a position of a work piece on the feed arrangement one embodiment of the invention includes a mechanical scanner and/or a position scanner, in particular a laser scanner. This does not preclude that work pieces with a predetermined orientation are placed onto the feed arrangement or aligned after placement on the feed arrangement. The mechanical scanner and/or position scanner is configured to determine an actual positon of the work pieces on the feed arrangement and to consider the actual position during a subsequent machining at machining stations.

In order to machine the work pieces embodiments of the invention provide machining robots and/or portal machine tools at the machining stations of the autonomous production line according to the invention.

The machining robots and/or portal machine tools are advantageously controlled by a computerized numerical control (CNC) and receive data for machining the respective work piece and regarding its position on the feed arrangement determined by a scanner or position scanner when a scanning and/or a position scanning are available. The machining data is adapted to the position of the work piece on the feed arrangement. The machining robots move a tool corresponding to the respective machining relative the work piece and drive the tool to rotate unless the tool operates without rotating. Advantageously the machining robots and/or portal machine tools can select different tools from magazines or similar. The machining robots are advantageously stationary and rotatable or pivotable and advantageously include plural arms that are linked together or are movable in other manners.

### BRIEF DESCRIPTION OF THE DRAWINGS

The invention is subsequently described in more detail based on an embodiment with reference to a drawing figure, wherein:

FIG. 1 illustrates the autonomous production line according to the invention in a top view;

FIG. 2 illustrates the production line according to FIG. 1 in a side view;

FIG. 3 illustrates a cross section of the production line according to FIGS. 1 and 2 according to a line in FIG. 2;

FIG. 4 illustrates a second embodiment of the autonomous production line according to the invention in a top view;

FIG. 5 illustrates the production line according to FIG. 4 in a side view; and

FIG. 6 illustrates a face view of an end of the production line according to FIGS. 4 and 5.

### DETAILED DESCRIPTION OF THE INVENTION

The drawing figure provides a simplified schematic representation as a basis for the description and for an understanding of the invention.

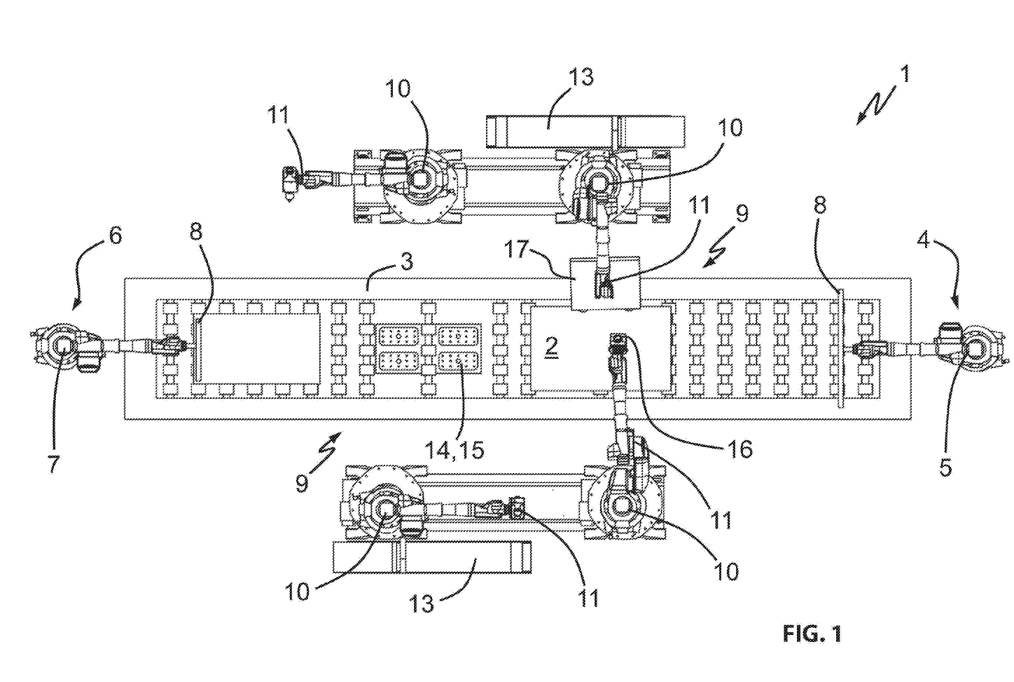

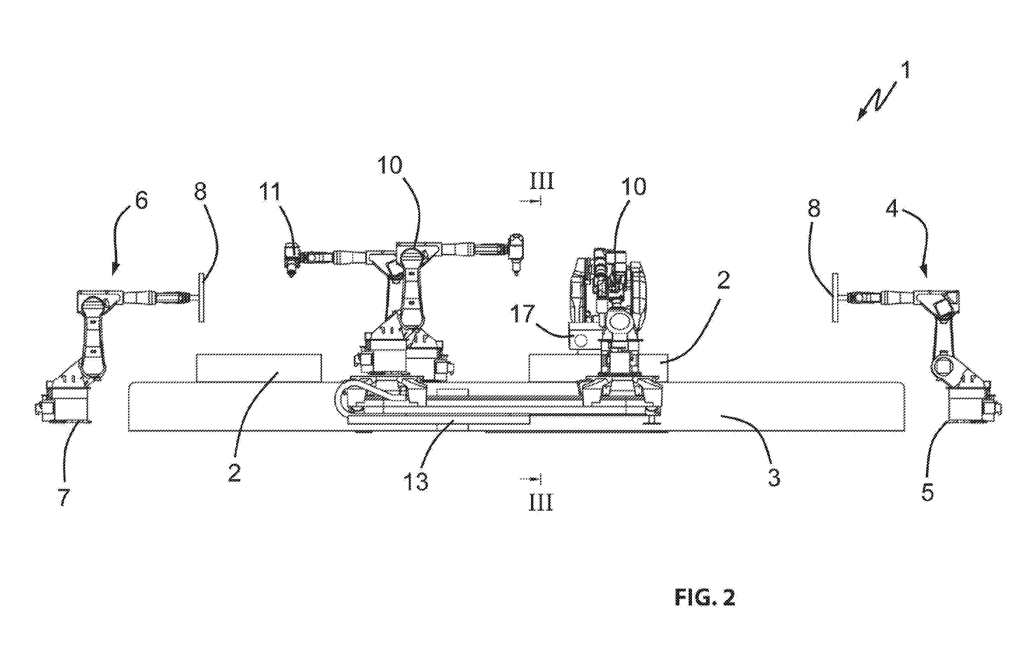

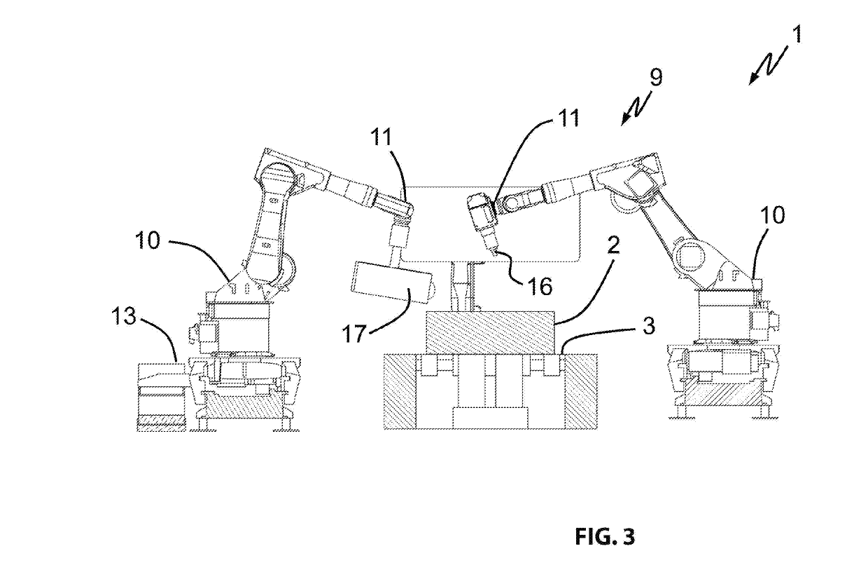

The autonomous production line 1 according to the invention illustrated in FIGS. 1-3 is used for machining work pieces 2, like e.g. plates e.g. by sawing, milling, boring, grinding, in case of sheet metal also bending is possible. The arrangement 1 includes a continuous conveyor in the embodiment a roller conveyor configured as a feed arrangement 3 which, however, is not operated continuously but in an intermittent manner. Rollers of the roller conveyor are individually drivable at least in axles, so that work pieces 2 are movable independently from each other at different locations of the roller conveyor. At one end of the feed arrangement 3 the arrangement 1 includes a placement station 4 with a placement robot 5 and at another end an unloading station 6 with an unloading robot 7.

The placement robot 5 and the unloading robot 7 are stationary industrial robots that are rotatable about vertical axes and that include two pivot arms wherein a first pivot arm is supported pivotable about a horizontal axis at a base that is rotatable about a vertical axis and a second pivot arm is pivotably supported about another horizontal axis at the first pivot arm. The second pivot arm includes a pivot head that is pivotable about one or two axes and rotatable about a second or a third axis at which pivot head a flat frame with suction cups that form a suction gripper 8 for gripping a work piece 2 by vacuum is arranged.

The placement robot 5 grips a prepared work piece 2 with its suction gripper 8 and places the prepared work piece onto the roller conveyor forming the feed arrangement 3. The unloading robot 7 at the other end of the feed arrangement 3 grips a finished work piece 2, lifts it from the feed arrangement 3 and places it for example onto a provided non-illustrated pallet or a provided and also not illustrated transport container like e.g. a cardboard box.

The arrangement 1 includes one or plural machining stations 9 with one or plural machining robots 10 along the feed arrangement 3. In the illustrated and described embodiment the arrangement 1 includes two machining stations 9 respectively with two machining robots 10. The machining robots 10 of a machining station 9 are arranged opposite to one another at two sides of the roller conveyor forming the feed arrangement 3. In the embodiment the machining robots 10 are essentially configured identical to the placement robot 5 and the unloading robot 7. The machining robots 10 are rotatable about vertical axes and include two pivot arms that are pivotably connected with each other and pivotably connected with a base that is rotatable about the vertical axes.

A pivot head 11 of the machining robots 10 includes a rotation drive and an automatic clamping arrangement for a non-illustrated tool like e.g. a drill, a saw, a milling bit or a grinding tool. Also non-rotating tools can be clamped. The tools are automatically retrieved by the machining robots 10 from magazines 13. The work pieces 2 can also be for example laser cut or water jet cut.

The feed arrangement 3 includes a fixing device 14 at the machining stations 9 for supporting the work pieces 2 during machining. In the embodiment the fixing devices 14 include suction tables 15. In the embodiment the work pieces 2 are not clamped mechanically which is possible but they are fixed on the suction tables with a vacuum. The suction tables include plates with holes on which the work pieces 2 rest at or in the machining stations 9. Air is sucked in through the holes so that a contacting work piece 2 is held by vacuum. Other fixing arrangements are possible, for example clamping arrangements which clamp a work piece 2 mechanically with fixed and/or movable clamping jaws (not illustrated). The suction tables are only operated, this means air is only pulled out when a work piece 2 is in contact which shall be fixed on the feed arrangement 3.

The feed arrangement 3 conveys the applied work pieces to the machining stations 9 where they are retained by the fixing arrangements 14 and machined by the machining robots 10 with the tools 12. After machining the fixing arrangements 14 are turned off and the work pieces 2 are conveyed further to another or to a next machining station 9 or to the unloading station 6 and machined further or retrieved from the feed arrangement 3. Because the work pieces 2 can be fed independently from each other a work piece 2 can be fed while another work piece is being machined. A work piece 2 can also be fed in a different direction or with a different speed than another work piece.

In order to determine a position of the work pieces 2 on the feed arrangement 3 the arrangement 1 according to the invention includes a mechanical scanner 16 and a laser scanner configured as a position scanner 17 which are retrieved by the machining robots 10 from the magazines 13 as measurement tools like the machining tools and which are clamped by the automatic clamping arrangements of the machining robots 10. The machining robots 10 receive data for machining the respective work piece 2 to be machined wherein the data is corrected according to a position of the work piece 2 on the feed arrangement 3 so that a movement of the tools 12 during machining is adapted to an actual position of the respective work piece 2. For a coarse first processing in a first machining station 9 the position of the work piece 2 on the feed arrangement 3 is mechanically determined by the scanner 16. For a fine machining or finishing of the work pieces 2 a position of the work pieces 2 is detected by the laser scanner 17 in a second, additional or last machining station 9.

The mechanical scanner 16 and in particular the position scanner 17 are configured to precisely detect a shape and size of the work piece 2. Thus a detection of the work piece 2 and a nominal/actual comparison are possible which is computed into the machining. For example the tools can be selected program controlled based on an actual shape, size and possibly hardness of the work pieces 2. Deficiencies of the work pieces 2 can also be detected. Furthermore a hardness measurement of the work pieces 2 is possible by impressing respective test bodies that are clamped by the automatic clamping devices of the machining robots 10 into the work pieces 2.

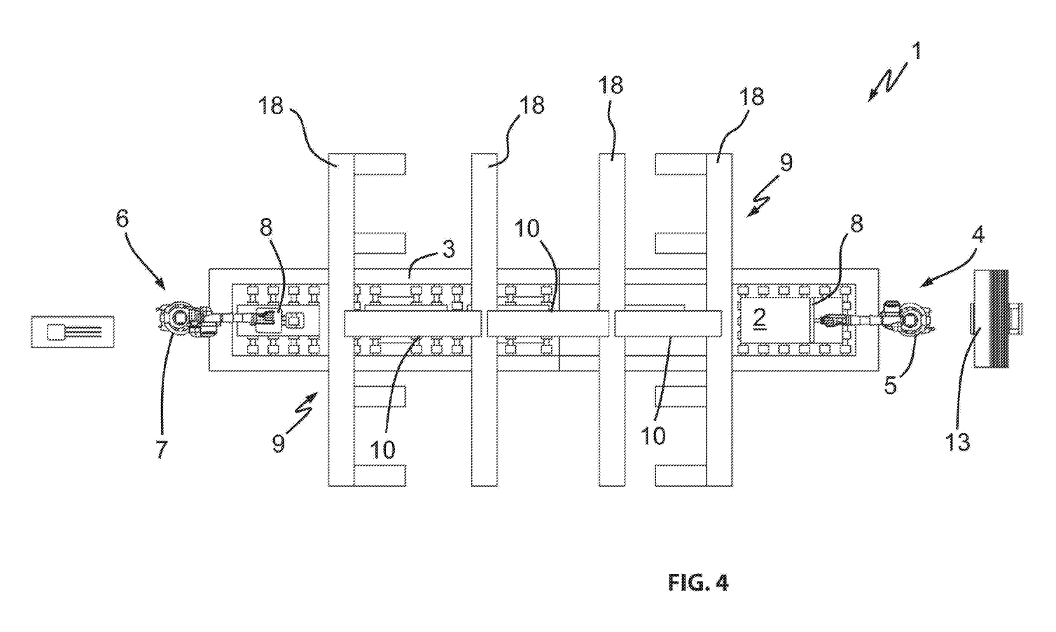

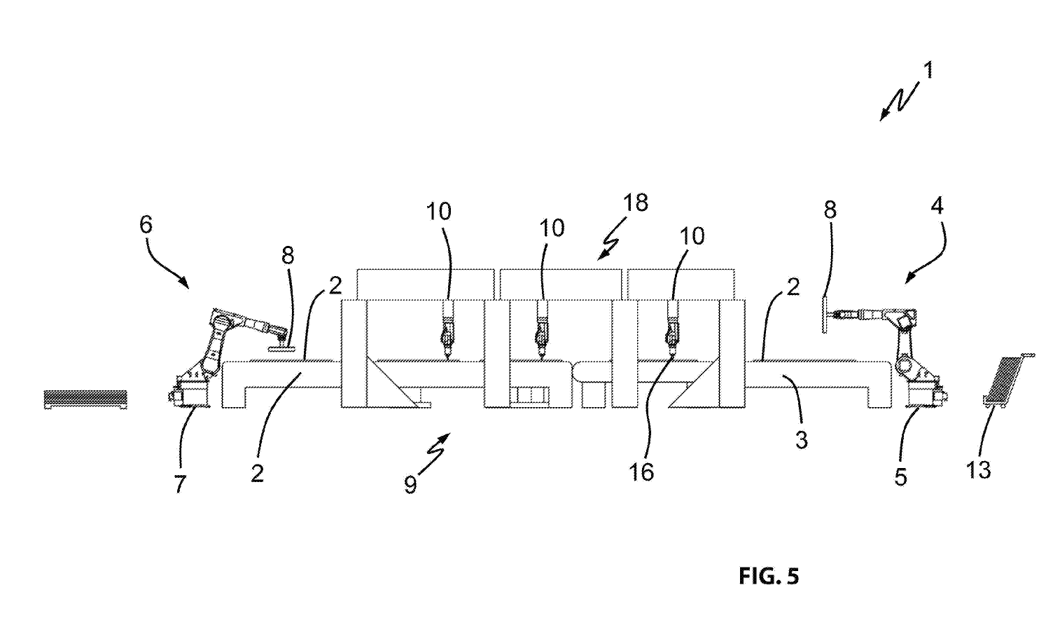

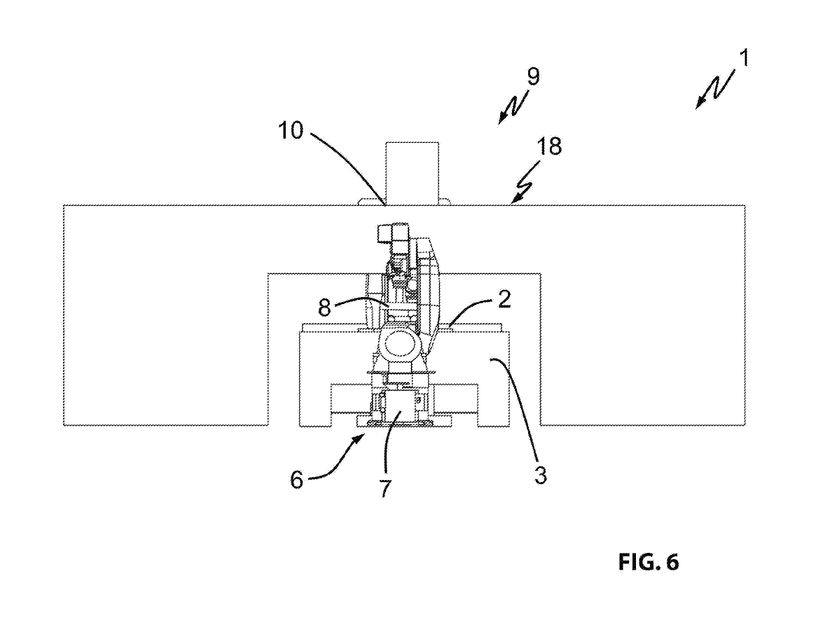

In FIGS. 4-6 the machining stations 9 of the autonomous production line 1 include portal machine tools 18 instead of the machining robots 10. Furthermore the two production lines 1 are configured identical and function in the same way so that the description of FIGS. 1-3 is referred to for providing descriptions regarding FIGS. 4-6 in order to avoid repetition. Identical or equivalent components in FIGS. 4-6 are designated with identical reference numerals like in FIGS. 1-3. A production line can be provided which includes machining robots and portal machine tools or also other machine tools at the machining stations (not-illustrated).

What is claimed is:

1. An autonomous production line for machining work pieces, the autonomous production line comprising:
a feed arrangement configured to feed the work pieces to and from at least one machining station at which the work pieces are machined on the feed arrangement.

2. The autonomous production line according to claim 1, wherein the autonomous production line includes plural machining stations along a path of the autonomous production line or on different sides of the feed arrangement.

3. The autonomous production line according to claim 1, wherein the autonomous production line includes a placement station which places the work pieces on the feed arrangement and an unloading station which retrieves the work pieces from the feed arrangement.

4. The autonomous production line according to claim 1, wherein the
feed arrangement includes a fixing arrangement for each machining station, and
wherein the fixing arrangement fixes the work pieces on the feed arrangement during machining.

5. The autonomous production line according to claim 4, wherein the fixing arrangement includes a suction gripper or a suction table configured to fix the work pieces on the feed arrangement during machining.

6. The autonomous production line according to claim 1, wherein the work pieces are movable independently from each other at different locations of the feed arrangement.

7. The autonomous production line according to claim 1, wherein the production line includes a mechanical scanner or a laser scanner configured to determine a position of the work pieces on the feed arrangement.

8. The autonomous production line according to claim 1, wherein the at least one machining station includes a machining robot or a portal machine tool.

9. The autonomous production line according to claim 1, wherein the at least one machining station includes a magazine for tools.
